(19) United States
(12) Patent Application Publication
(10) Pub. No.: US 2026/0113091 A1
(43) Pub. Date: Apr. 23, 2026

(54) APPARATUS AND METHOD FOR FEEDING BACK CHANNEL STATE INFORMATION AT VARIABLE RATES IN WIRELESS COMMUNICATION SYSTEM

(71) Applicant: LG Electronics Inc., Seoul (KR)

(72) Inventors: Minseok JO, Seoul (KR); Sangrim LEE, Seoul (KR); Kyung Ho LEE, Seoul (KR); Bonghoe KIM, Seoul (KR); Ikjoo JUNG, Seoul (KR); Yeong Jun KIM, Seoul (KR)

(21) Appl. No.: 19/116,011

(22) PCT Filed: Sep. 27, 2022
(86) PCT No.: PCT/KR2022/014411

§ 371 Date: Mar. 27, 2025

(51) Int. Cl. H04B 7/06; H04L 5/00

(52) U.S. Cl. CPC H04B 7/0626; H04L 5/0048

(57) ABSTRACT

The present disclosure relates to feeding back channel state information with a variable rate in a wireless communication system, and a method for operating a user equipment (UE) may include receiving configuration information related to channel state information (CSI) feedback, receiving reference signals based on the configuration information, generating CSI feedback information based on the reference signals, and transmitting the CSI feedback information. The CSI feedback information may include a corresponding number of CSI values to a feedback rate.

### TECHNICAL FIELD

The present disclosure relates to a wireless communication system, and particularly, to an apparatus and method for feeding back channel state information with a variable rate in a wireless communication system.

### BACKGROUND ART

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (mMTC) for providing various services anytime anywhere by connecting a plurality of apparatuses and things but also communication systems considering services/user equipments (UEs) sensitive to reliability and latency have been proposed. To this end, various technical configurations have been proposed.

### DISCLOSURE

### Technical Problem

The present disclosure may provide an apparatus and method for effectively feeding back channel state information (CSI) in a wireless communication system.

The present disclosure may provide an apparatus and method for adaptively adjusting a feedback rate of CSI in a wireless communication system.

The present disclosure may provide an apparatus and method for generating a set of CSI values, a portion or all of which may be used to reconstruct channel information, in a wireless communication system.

The present disclosure may provide an apparatus and method for generating a corresponding number of CST values to a given feedback rate in a wireless communication system.

The present disclosure may provide an apparatus and method for extracting an additional CSI value from an encoder neural network in a wireless communication system.

The present disclosure may provide an apparatus and method for extracting an additional CSI value from a hidden layer of an encoder neural network in a wireless communication system.

The present disclosure may provide an apparatus and method for extracting an accumulable feature value before an endpoint of skip connection of an encoder neural network in a wireless communication system.

The present disclosure may provide an apparatus and method for obtaining channel information by using a corresponding number of CST values to a given feedback rate in a wireless communication system.

The present disclosure may provide an apparatus and method for determining channel information based on a plurality of CSI values in a wireless communication system.

The present disclosure may provide an apparatus and method for generating an input value of a decoder neural network by combining a plurality of CST values in a wireless communication system.

The present disclosure may provide an apparatus and method for generating an input value of a decoder neural network through an arithmetic operation for a plurality of CSI values in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

### Technical Solution

As an example of the present disclosure, a method for operating a user equipment (UE) in a wireless communication system may include receiving configuration information related to channel state information (CSI) feedback, receiving reference signals based on the configuration information, generating CSI feedback information based on the reference signals, and transmitting the CSI feedback information. The CSI feedback information may include a corresponding number of CSI values to a feedback rate.

As an example of the present disclosure, a method for operating a base station in a wireless conjunction system may include transmitting configuration information related to channel state information (CSI) feedback, transmitting reference signals based on the configuration information, receiving CSI feedback information corresponding to the reference signals, and obtaining channel information based on the CSI feedback information. The CST feedback information may include a corresponding number of CSI values to a feedback rate.

As an example of the present disclosure, a user equipment (UE) in a wireless communication system may include a transceiver and a processor coupled with the transceiver, and the processor may be configured to receive configuration information related to channel state information (CSI) feedback, to receive reference signals based on the configuration information, to generate CSI feedback information based on the reference signals, and to transmit the CST feedback information. The CST feedback information may include a corresponding number of CSI values to a feedback rate.

As an example of the present disclosure, a base station in a wireless communication may include a transceiver and a processor coupled with the transceiver, and the processor may be configured to transmit configuration information related to channel state information (CSI) feedback, to transmit reference signals based on the configuration information, to receive CSI feedback information corresponding to the reference signals, and to obtain channel information based on the CSI feedback information. The CST feedback information may include a corresponding number of CSI values to a feedback rate.

As an example of the present disclosure, a communication device may include at least one processor and at least one computer memory coupled with the at least one processor and storing an instruction that instructs operations when being executed by the at least one processor. The operations may include receiving configuration information related to channel state information (CSI) feedback, receiving reference signals based on the configuration information, generating CST feedback information based on the reference signals, and transmitting the CSI feedback information. The CSI feedback information may include a corresponding number of CSI values to a feedback rate.

As an example of the present disclosure, a non-transitory computer-readable medium storing at least one instruction may include the at least one instruction that is executable by a processor. The at least one instruction may control a device to receive configuration information related to channel state information (CSI) feedback, to receive reference signals based on the configuration information, to generate CSI feedback information based on the reference signals, and to transmit the CSI feedback information. The CST feedback information may include a corresponding number of CST values to a feedback rate.

The above-described aspects of the present disclosure are merely a part of exemplary embodiments of the present disclosure, and various embodiments reflecting technical features of the present disclosure may be derived and understood by those skilled in the art based on the detailed description of the present disclosure below.

### Advantageous Effects

As is apparent from the above description, the embodiments of the present disclosure have the following effects.

According to the present disclosure, it is possible to adaptively adjust a feedback rate of channel state information according to a channel environment.

Effects obtained in the present disclosure are not limited to the above-mentioned effects, and other effects not mentioned above may be clearly derived and understood by those skilled in the art to which a technical configuration of the present disclosure is applied, from the following description of embodiments of the present disclosure. That is, effects, which are not intended when implementing a configuration described in the present disclosure, may also be derived by those skilled in the art from the embodiments of the present disclosure.

### DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless apparatus applicable to the present disclosure.

FIG. 3 illustrates another example of a wireless device applicable to the present disclosure.

FIG. 4 illustrates an example of a hand-held device applicable to the present disclosure.

FIG. 5 illustrates an example of a car or an autonomous driving car applicable to the present disclosure.

FIG. 6 illustrates an example of artificial intelligence (AI) device applicable to the present disclosure.

FIG. 7 illustrates a method of processing a transmitted signal applicable to the present disclosure.

FIG. 8 illustrates an example of a communication structure providable in a 6th generation (6G) system applicable to the present disclosure.

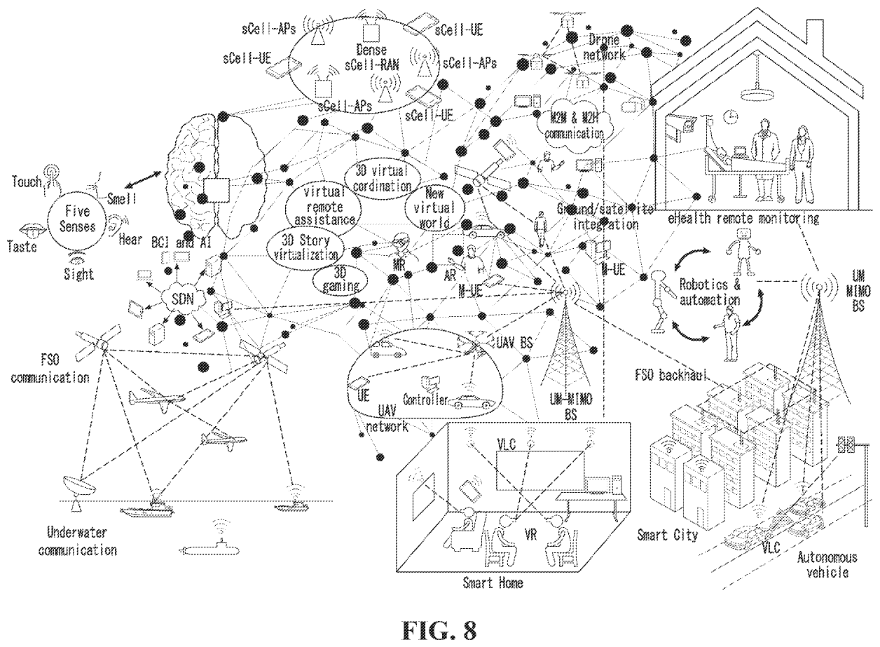

FIG. 9 illustrates an electromagnetic spectrum applicable to the present disclosure.

FIG. 10 illustrates a THz communication method applicable to the present disclosure.

FIG. 11 illustrates a perceptron architecture in an artificial neural network applicable to the present disclosure.

FIG. 12 illustrates an artificial neural network architecture applicable to the present disclosure.

FIG. 13 illustrates a deep neural network applicable to the present disclosure,

FIG. 14 illustrates a convolutional neural network applicable to the present disclosure.

FIG. 15 illustrates a filter operation of a convolutional neural network applicable to the present disclosure.

FIG. 16 illustrates a neural network architecture with a recurrent loop applicable to the present disclosure.

FIG. 17 illustrates an operational structure of a recurrent neural network applicable to the present disclosure.

FIG. 18 illustrates an example of a neural network architecture for channel state information (CSI) feedback.

FIG. 19 illustrates an example of a processing process of a CSI matrix in a neural network for channel state information feedback.

FIG. 20 illustrates an example of a residual block available in a neural network for channel state information feedback.

FIG. 21 illustrates an example of a residual block to which a skip connection is added.

FIG. 22 illustrates an example of an encoder and decoder structure for CSI feedback.

FIG. 23 illustrates a concept of CSI feedback that supports a variable feedback rate according to an embodiment of the present disclosure.

FIG. 24 illustrates a concept of feature extraction before skip connection for supporting a variable feedback rate according to an embodiment of the present disclosure.

FIG. 25 illustrates an example of an encoder neural network that supports a variable feedback rate according to an embodiment of the present disclosure.

FIG. 26 illustrates examples of reconstructed channel information according to a change of feedback rate according to an embodiment of the present disclosure.

FIG. 27 illustrates an example of a procedure of obtaining channel information based on CST feedback according to an embodiment of the present disclosure.

FIG. 28 illustrates an example of a procedure of operating a decoder neural network of a CSI network according to an embodiment of the present disclosure.

FIG. 29 illustrates an example of a procedure of transmitting CST feedback according to an embodiment of the present disclosure.

FIG. 30 illustrates an example of a procedure of operating an encoder neural network of a CSI network according to an embodiment of the present disclosure.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G; NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document, LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

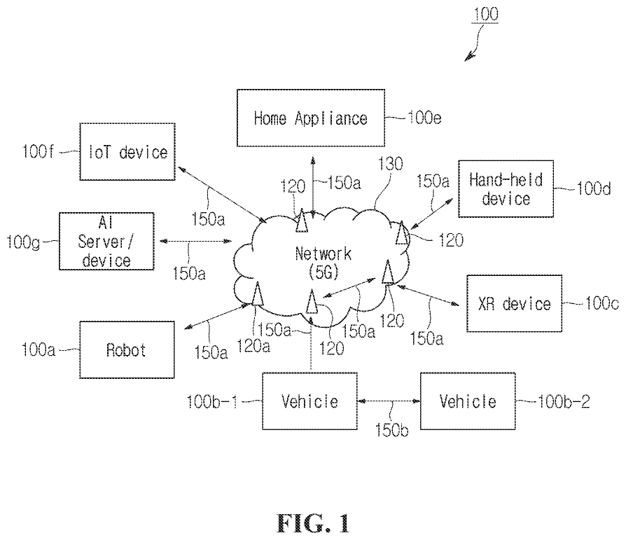

FIG. 1 illustrates an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AT) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120, Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (TAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

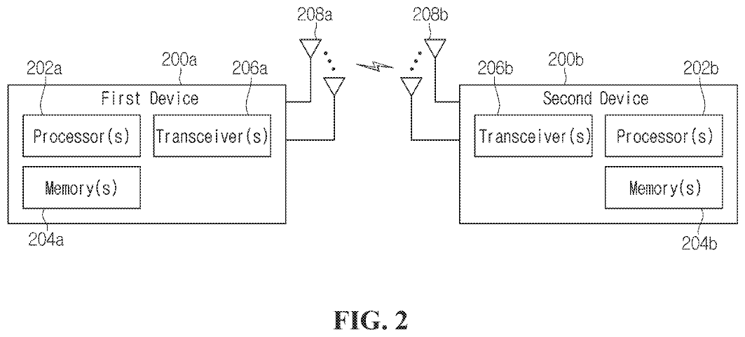

FIG. 2 illustrates an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR), The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc, described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

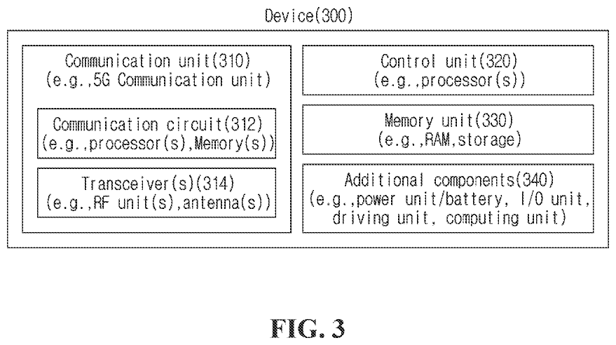

FIG. 3 illustrates another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIG. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

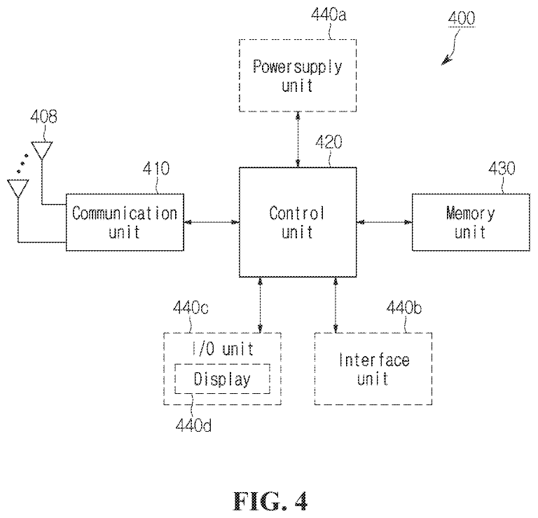

FIG. 4 illustrates an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400, In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

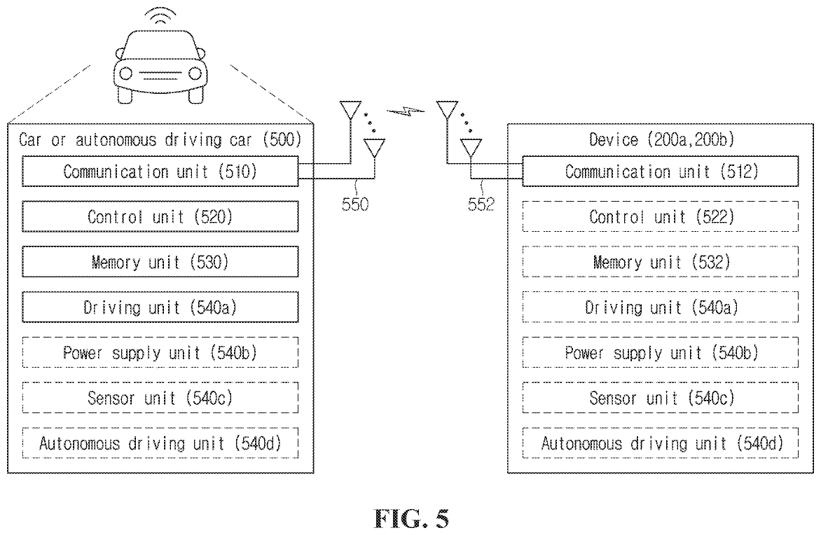

FIG. 5 illustrates an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

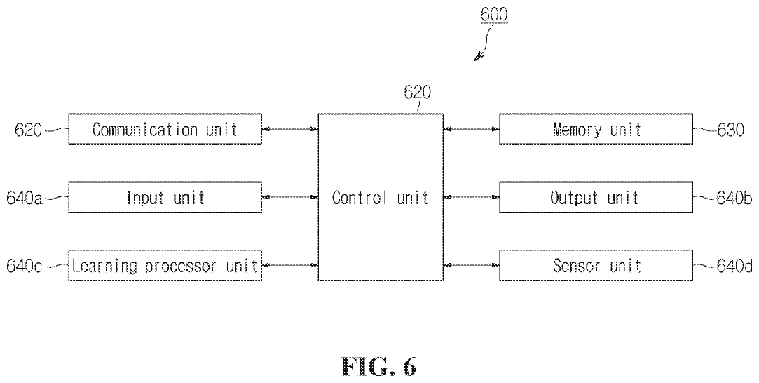

FIG. 6 is a diagram illustrating an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 6, the AI device 600 may include a communication unit 610, a control unit 620, a memory unit 630, an input/output unit 640a/640b, a learning processor unit 640c and a sensor unit 640d. Blocks 610 to 630/640A to 640D may correspond to blocks 310 to 330/340 of FIG. 3, respectively.

The communication unit 610 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 610 may transmit information in the memory unit 630 to an external device or send a signal received from an external device to the memory unit 630.

The control unit 620 may determine at least one executable operation of the AI device 600 based on information determined or generated using a data analysis algorithm or machine learning algorithm. In addition, the control unit 620 may control the components of the AI device 600 to perform the determined operation. For example, the control unit 620 may request, search, receive, or utilize the data of the learning processor 640c or the memory unit 630, and control the components of the AT device 600 to perform predicted operation or operation determined to be preferred among at least one executable operation. In addition, the control unit 620 collects history information including a user's feedback on the operation content or operation of the AI device 600, and stores it in the memory unit 630 or the learning processor 640c or transmit it to an external device such as the AT server (140 in FIG. 1). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensor unit 640. Also, the memory unit 630 may store control information and/or software code required for operation/execution of the control unit 620.

The input unit 640a may obtain various types of data from the outside of the AI device 600. For example, the input unit 620 may obtain learning data for model learning, input data to which the learning model is applied, etc. The input unit 640a may include a camera, a microphone and/or a user input unit, etc. The output unit 640b may generate audio, video or tactile output. The output unit 640b may include a display unit, a speaker and/or a haptic module. The sensor unit 640 may obtain at least one of internal information of the AI device 600, surrounding environment information of the AI device 600 or user information using various sensors. The sensor unit 640 may include a proximity sensor, an illuminance sensor, an acceleration sensor, a magnetic sensor, a gyro sensor, an inertial sensor, an RGB sensor, in IR sensor, a fingerprint recognition sensor, an ultrasonic sensor, an optical sensor, a microphone, and/or a radar.

The learning processor unit 640c may train a model composed of an artificial neural network using learning data. The learning processor unit 640c may perform AI processing together with the learning processor unit of the AI server (140 in FIG. 1). The learning processor unit 640c may process information received from an external device through the communication unit 610 and/or information stored in the memory unit 630. In addition, the output value of the learning processor unit 640c may be transmitted to an external device through the communication unit 610 and/or stored in the memory unit 630.

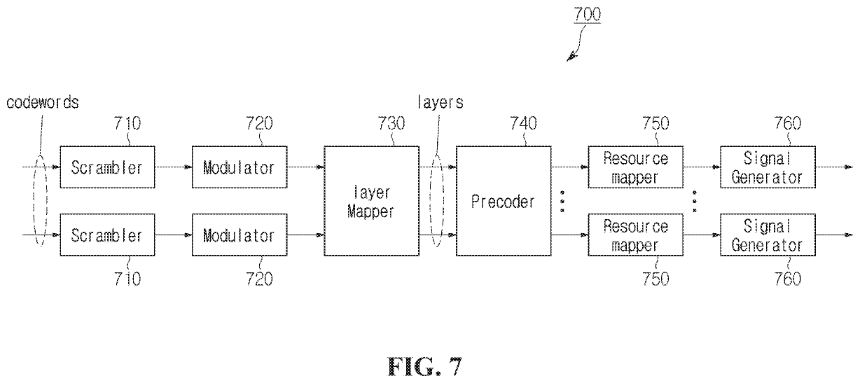

FIG. 7 illustrates a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202a and 202b and/or the transceiver 206a and 206b of FIG. 2. In addition, for example, the hardware element of FIG. 7 may be implemented in the processors 202a and 202b of FIG. 2 and/or the transceivers 206a and 206b of FIG. 2. For example, blocks 710 to 760 may be implemented in the processors 202a and 202b of FIG. 2. In addition, blocks 710 to 750 may be implemented in the processors 202a and 202b of FIG. 2 and a block 760 may be implemented in the transceivers 206a and 206b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a. UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), in-phase shift keying (nm-PSK), n-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”. “holographic connectivity” and “ubiquitous connectivity”, and the 6G system may satisfy the requirements shown in Table 4 below That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AT integrated communication, tactile Internet, high throughput, high network capacity, high energy efficiency, low backhaul and access network congestion and enhanced data security.

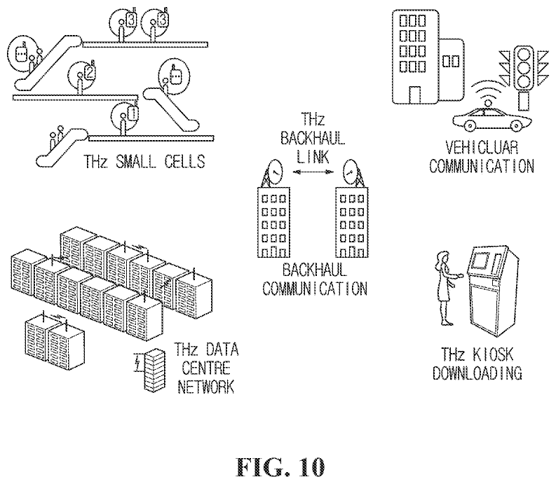

FIG. 10 illustrates an example of a communication structure providable in a 6G system applicable to the present disclosure.

Referring to FIG. 10, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

The most important and newly introduced technology for the 6G system is AI. AI was not involved in the 4G system. 50 systems will support partial or very limited AI. However, the 6G system will support AI for full automation. Advances in machine learning will create more intelligent networks for real-time communication in 6G. Introducing AI in communication may simplify and enhance real-time data transmission. AI may use a number of analytics to determine how complex target tasks are performed. In other words, AI may increase efficiency and reduce processing delay.

Time consuming tasks such as handover, network selection, and resource scheduling may be performed instantly by using AI. AI may also play an important role in machine-to-machine, machine-to-human and human-to-machine communication. In addition, AI may be a rapid communication in a brain computer interface (BCI). AI-based communication systems may be supported by metamaterials, intelligent structures, intelligent networks, intelligent devices, intelligent cognitive radios, self-sustained wireless networks, and machine learning.

Recently, attempts have been made to integrate AI with wireless communication systems, but application layers, network layers, and in particular, deep learning have been focused on the field of wireless resource management and allocation. However, such research is gradually developing into the MAC layer and the physical layer, and in particular, attempts to combine deep learning with wireless transmission are appearing in the physical layer. AI-based physical layer transmission means applying a signal processing and communication mechanism based on an AI driver rather than a traditional communication framework in fundamental signal processing and communication mechanisms. For example, deep learning-based channel coding and decoding, deep learning-based signal estimation and detection, deep learning-based multiple input multiple output (MIMO) mechanism, and AI-based resource scheduling and allocation may be included.

Machine learning may be used for channel estimation and channel tracking, and may be used for power allocation, interference cancellation, and the like in a downlink (DL) physical layer. Machine learning may also be used for antenna selection, power control, symbol detection, and the like in a MIMO system.

However, the application of DNN for transmission in the physical layer may have the following problems.

Deep learning-based AI algorithms require a lot of training data to optimize training parameters. However, due to limitations in obtaining data in a specific channel environment as training data, a lot of training data is used offline. This is because static training on training data in a specific channel environment may cause a contradiction between diversity and dynamic characteristics of a radio channel.

In addition, current deep learning mainly targets real signals. However, the signals of the physical layer of wireless communication are complex signals. In order to match the characteristics of a wireless communication signal, additional research on a neural network that detects a complex domain signal is required.

Hereinafter, machine learning will be described in greater detail.

Machine learning refers to a series of operations for training a machine to create a machine capable of performing a task which can be performed or is difficult to be performed by a person. Machine learning requires data and a learning model. In machine learning, data learning methods may be largely classified into three types: supervised learning, unsupervised learning, and reinforcement learning.

Neural network learning is to minimize errors in output. Neural network learning is a process of updating the weight of each node in the neural network by repeatedly inputting learning data to a neural network, calculating the output of the neural network for the learning data and the error of the target, and backpropagating the error of the neural network from the output layer of the neural network to the input layer in a direction to reduce the error.

Supervised learning uses learning data labeled with correct answers in the learning data, and unsupervised learning may not have correct answers labeled with the learning data. That is, for example, learning data in the case of supervised learning related to data classification may be data in which each learning data is labeled with a category. Labeled learning data is input to the neural network, and an error may be calculated by comparing the output (category) of the neural network and the label of the learning data. The calculated error is backpropagated in a reverse direction (i.e., from the output layer to the input layer) in the neural network, and the connection weight of each node of each layer of the neural network may be updated according to backpropagation. The amount of change in the connection weight of each updated node may be determined according to a learning rate. The neural network's computation of input data and backpropagation of errors may constitute a learning cycle (epoch). The learning rate may be applied differently according to the number of iterations of the learning cycle of the neural network. For example, in the early stages of neural network learning, a high learning rate is used to allow the neural network to quickly achieve a certain level of performance to increase efficiency, and in the late stage of learning, a low learning rate may be used to increase accuracy.

A learning method may vary according to characteristics of data. For example, when the purpose is to accurately predict data transmitted from a transmitter in a communication system by a receiver, it is preferable to perform learning using supervised learning rather than unsupervised learning or reinforcement learning.

The learning model corresponds to the human brain, and although the most basic linear model may be considered, a paradigm of machine learning that uses a neural network structure with high complexity such as artificial neural networks as a learning model is referred to as deep learning.

The neural network cord used in the learning method is largely classified into deep neural networks (DNN), convolutional deep neural networks (CNN), and recurrent Boltzmann machine (RNN), and this learning model may be applied.

### Terahertz (THz) Communication

THz communication is applicable to the 6G system. For example, a data rate may increase by increasing bandwidth. This may be performed by using sub-THz communication with wide bandwidth and applying advanced massive MIMO technology.

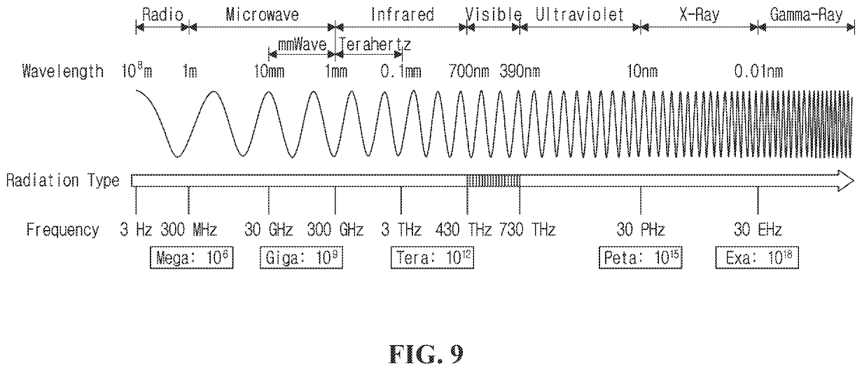

FIG. 9 illustrates an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main pat of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

FIG. 10 illustrates a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Artificial Intelligence System

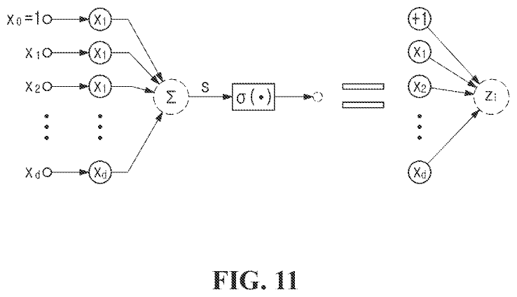

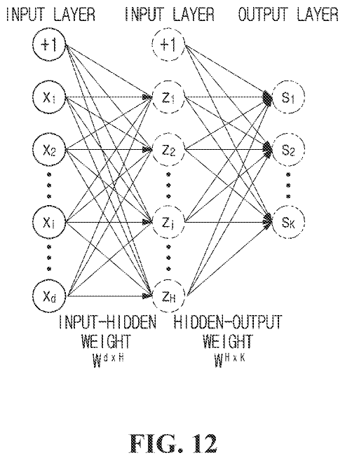

FIG. 11 illustrates a perceptron architecture in an artificial neural network applicable to the present disclosure. In addition, FIG. 12 illustrates an artificial neural network architecture applicable to the present disclosure.

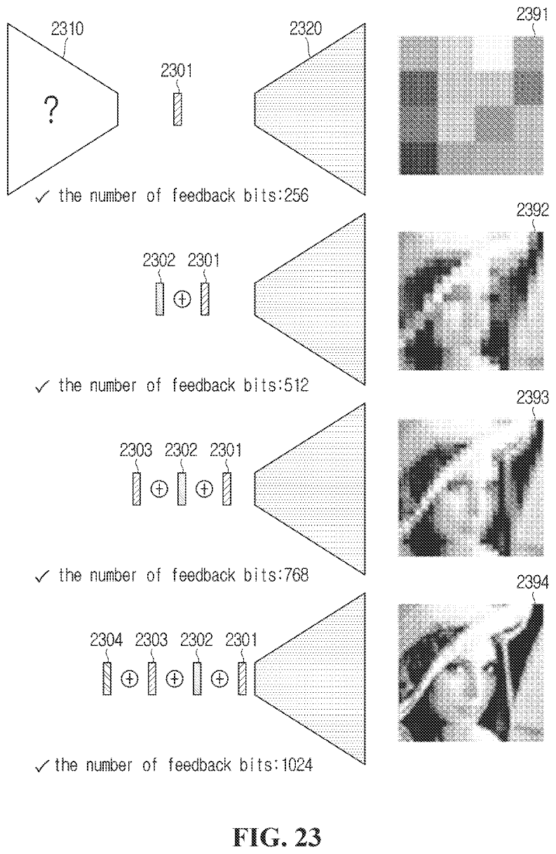

As described above, an artificial intelligence system may be applied to a 6G system. Herein, as an example, the artificial intelligence system may operate based on a learning model corresponding to the human brain, as described above. Herein, a paradigm of machine learning, which uses a neural network architecture with high complexity like artificial neural network, may be referred to as deep learning. In addition, neural network cores, which are used as a learning scheme, are mainly a deep neural network (DNN), a convolutional deep neural network (CNN), and a recurrent neural network (RNN). Herein, as an example referring to FIG. 23, an artificial neural network may consist of a plurality of perceptrons. Herein, when an input vector x={x₁, x₂, . . . , x_{d}} is input, each component is multiplied by a weight {W₁, W₂, . . . , W_{d}}, results are all added up, and then an activation function σ( ) is applied, of which the overall process may be referred to as a perceptron. For a large artificial neural network architecture, when expanding the simplified perceptron structure illustrated in FIG. 11, an input may be applied to different multidimensional perceptrons. For convenience of explanation, an input value or an output value will be referred to as a node.

Meanwhile, the perceptron structure illustrated in FIG. 11 may be described to consist of a total of 3 layers based on an input value and an output value. An artificial neural network, which has H (d+1)-dimensional perceptrons between a 1st layer and a 2nd layer and K (H+1)-dimensional perceptrons between the 2nd layer and a 3rd layer, may be expressed as in FIG. 12.

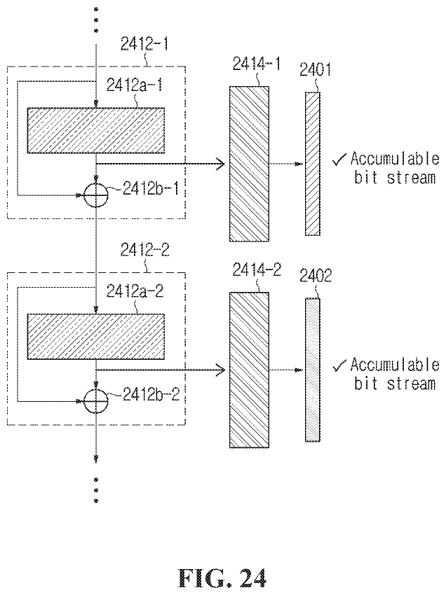

Herein, a layer, in which an input vector is located, is referred to as an input layer, a layer, in which a final output value is located, is referred to as an output layer, and all the layers between the input layer and the output layer are referred to as hidden layers. As an example, 3 layers are disclosed in FIG. 24, but since an input layer is excluding in counting the number of actual artificial neural network layers, it can be understood that the artificial neural network illustrated in FIG. 12 has a total of 2 layers. An artificial neural network is constructed by connecting perceptrons of a basic block two-dimensionally.

The above-described input layer, hidden layer and output layer are commonly applicable not only to multilayer perceptrons but also to various artificial neural network architectures like CNN and RNN, which will be described below. As there are more hidden layers, an artificial neural network becomes deeper, and a machine learning paradigm using a sufficiently deep artificial neural network as a learning model may be referred to as deep learning. In addition, an artificial neural network used for deep learning may be referred to as a deep neural network (DNN).

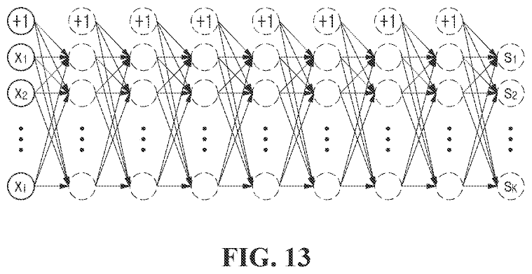

FIG. 13 illustrates a deep neural network applicable to the present disclosure.

Referring to FIG. 13, a deep neural network may be a multilayer perceptron consisting of 8 layers (hidden layers+output layer). Herein, the multilayer perceptron structure may be expressed as a fully-connected neural network. In a fully-connected neural network, there may be no connection between nodes in a same layer and only nodes located in neighboring layers may be connected with each other A DNN has a fully-connected neural network structure combining a plurality of hidden layers and activation functions so that it may be effectively applied for identifying a correlation characteristic between an input and an output. Herein, the correlation characteristic may mean a joint probability between the input and the output.

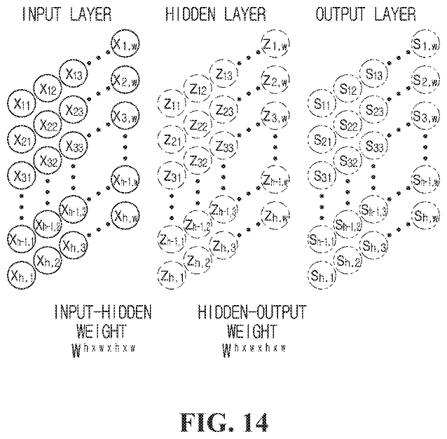

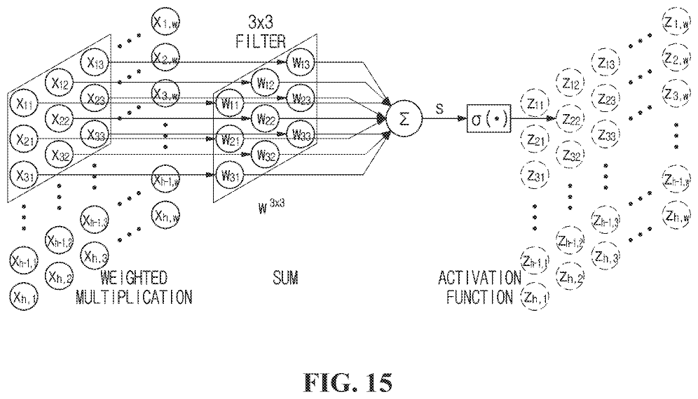

FIG. 14 illustrates a convolutional neural network applicable to the present disclosure. In addition, FIG. 15 illustrates a filter operation of a convolutional neural network applicable to the present disclosure.

As an example, depending on how to connect a plurality of perceptrons, it is possible to form various artificial neural network structures different from the above-described DNN. Herein, in the DNN, nodes located in a single layer are arranged in a one-dimensional vertical direction. However, referring to FIG. 14, it is possible to assume a two-dimensional array of w horizontal nodes and h vertical nodes (the convolutional neural network structures of FIG. 14). In this case, since a weight is applied to each connection in a process of connecting one input node to a hidden layer, a total of h×w weights should be considered. As there are h×w nodes in an input laver, a total of h²w² weights may be needed between two neighboring layers.

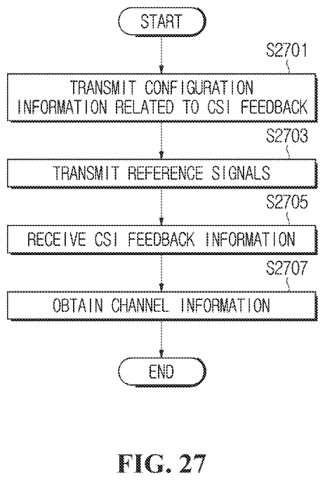

Furthermore, as the convolutional neural network of FIG. 14 has the problem of exponential increase in the number of weights according to the number of connections, the presence of a small filter may be assumed instead of considering every mode of connections between neighboring layers. As an example, as shown in FIG. 27, weighted summation and activation function operation may be enabled for a portion overlapped by a filter.

At this time, one filter has a weight corresponding to a number as large as its size, and learning of a weight may be performed to extract and output a specific feature on an image as a factor. In FIG. 15, a 3×3 filter may be applied to a top rightmost 3×3 area of an input layer, and an output value, which is a result of the weighted summation and activation function operation for a corresponding node, may be stored at z₂₂.

Herein, as the above-described filter scans the input layer while moving at a predetermined interval horizontally and vertically, a corresponding output value may be put a position of a current filter. Since a computation method is similar to a convolution computation for an image in the field of computer vision, such a structure of deep neural network may be referred to as a convolutional neural network (CNN), and a hidden layer created as a result of convolution computation may be referred to as a convolutional layer. In addition, a neural network with a plurality of convolutional layers may be referred to as a deep convolutional neural network (DCNN).

In addition, at a node in which a current filter is located in a convolutional layer, a weighted sum is calculated by including only a node in an area covered by the filter and thus the number of weights may be reduced. Accordingly, one filter may be so used as to focus on a feature of a local area. Thus, a CNN may be effectively applied to image data processing for which a physical distance in a two-dimensional area is a crucial criterion of determination. Meanwhile, a CNN may apply a plurality of filters immediately before a convolutional layer and create a plurality of output results through a convolution computation of each filter.

Meanwhile, depending on data properties, there may be data of which a sequence feature is important. A recurrent neural network structure may be a structure obtained by applying a scheme, in which elements in a data sequence are input one by one at each timestep by considering the distance variability and order of such sequence datasets and an output vector (hidden vector) output at a specific timestep is input with a very next element in the sequence, to an artificial neural network.

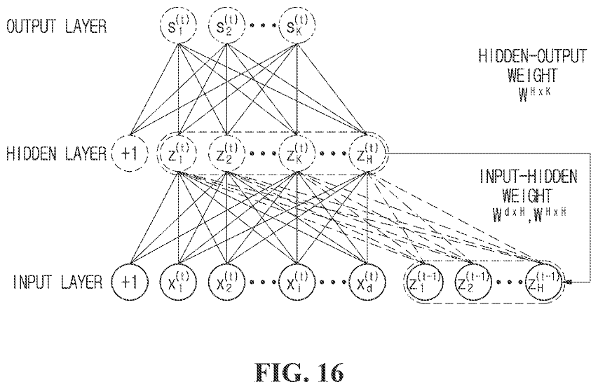

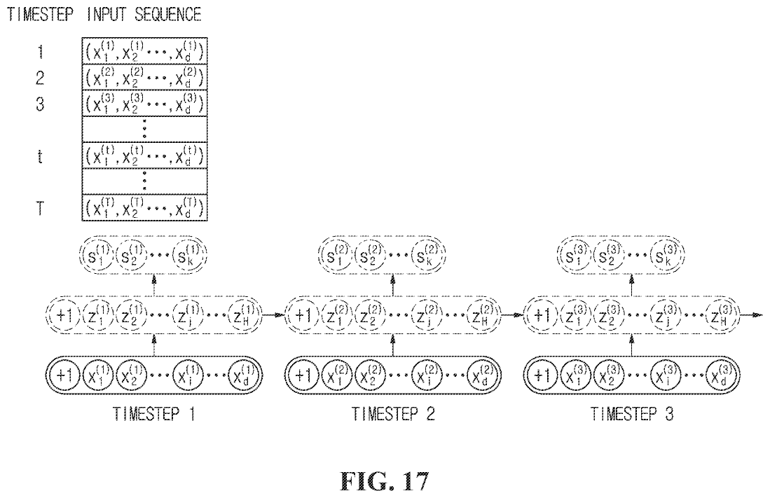

FIG. 16 illustrates a neural network architecture with a recurrent loop applicable to the present disclosure. FIG. 17 illustrates an operational structure of a recurrent neural network applicable to the present disclosure.

Referring to FIG. 16, a recurrent neural network (RNN) may have a structure which applies a weighted sum and an activation function by inputting hidden vectors {z₁^{(t-1)}, z₂^{(t-1)}, . . . , z_{H}^{(t-1)}} of an immediately previous timestep t−1 during a process of inputting elements {x₁^{(t)}, x₂^{(t)}, . . . , x_{d}^{(t)}} of a timestep t in a data sequence into a fully connected neural network. The reason why such hidden vectors are forwarded to a next timestep is because information in input vectors at previous timesteps is considered to have been accumulated in a hidden vector of a current timestep.

In addition, referring to FIG. 17, a recurrent neural network may operate in a predetermined timestep order for an input data sequence. Herein, as a hidden vector {z₁⁽¹⁾, z₂⁽¹⁾, . . . , z_{H}⁽¹⁾} at a time of inputting an input vector {x₁(t), x₂^{(t)}, . . . , x_{d}^{(t)}} of timestep 1 into a recurrent neural network is input together with an input vector {x₁⁽²⁾, x₂⁽²⁾, . . . , x_{d}⁽²⁾} of timestep 2, a vector {z₁⁽²⁾, z₂⁽²⁾, . . . , z_{H}⁽²⁾} of a hidden layer is determined through a weighted sum and an activation function. Such a process is iteratively performed at timestep 2, timestep 3 and until timestep T.

Meanwhile, when a plurality of hidden layers are allocated in a recurrent neural network, this is referred to as a deep recurrent neural network (DRNN). A recurrent neural network is so designed as to effectively apply to sequence data (e.g., natural language processing).

Apart from DNN, CNN and RNN, other neural network cores used as a learning scheme include various deep learning techniques like restricted Boltzmann machine (RBM), deep belief networks (DBN) and deep Q-Network, and these may be applied to such areas as computer vision, voice recognition, natural language processing, and voice/signal processing.

Recently, there are attempts to integrate AI with a wireless communication system, but these are concentrated in an application layer and a network layer and, especially in the case of deep learning, in a wireless resource management and allocation filed. Nevertheless, such a study gradually evolves to an MAC layer and a physical layer, and there are attempts to combine deep learning and wireless transmission especially in a physical layer. As for a fundamental signal processing and communication mechanism. AI-based physical layer transmission means application of a signal processing and communication mechanism based on an AI driver, instead of a traditional communication framework. For example, it may include deep learning-based channel coding and decoding, deep learning-based signal estimation and detection, deep learning-based MIMO mechanism, and AI-based resource scheduling and allocation.

### Specific Embodiments of the Present Disclosure

The present disclosure relates to a technology of feeding back channel state information (CSI) with a variable rate in a wireless communication system. Specifically, the present disclosure relates to an apparatus and method for variably operating a transmission rate of CSI feedback information in an architecture that generates and analyzes CST feedback information based on an artificial intelligence (AI) model.

In the present disclosure, an artificial neural network, which compresses and reconstructs CSI based on deep learning, is referred to as a ‘CSI network’. Recently, the architecture of a CSI network evolves in various ways.

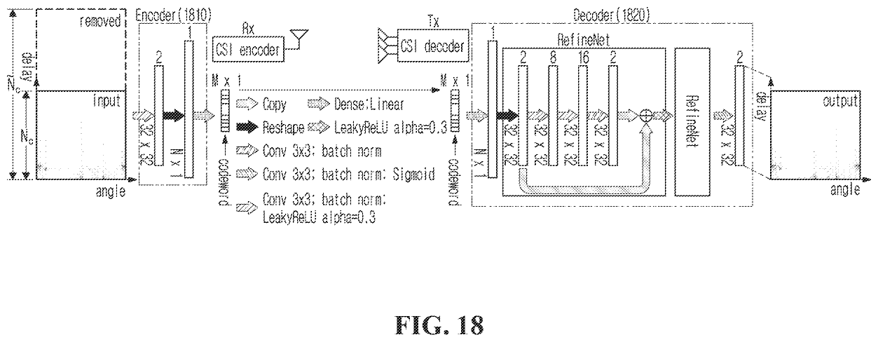

FIG. 18 illustrates an example of a neural network architecture for CSI feedback. FIG. 18 exemplifies CsiNet that is an example of a CSI network architecture. Referring to FIG. 18, a CSI network may consist of a CSI encoder 1810 and a CST decoder 1820. For example, in downlink where data transmission is performed from a base station to a UE, the base station may operate as a transmitter, and the UE may operate as a receiver. In downlink, a CSI encoder may be operated by a UE that is a receiver, and a CSI decoder may be operated by a base station that is a transmitter. In the present disclosure, for convenience of description, a case of downlink communication is assumed, but various embodiment described below are not limited to downlink but may be applied to other links such as uplink and sidelink.

A CSI encoder included in a UE may compress information on a channel state. Compressed information, which is an output of the CSI encoder, is delivered to a base station through uplink feedback. The base station may input the received compressed information into a CSI decoder, and the CSI decoder may reconstruct the channel state of the UE. In the present disclosure, for convenience of description, compressed information, which is an output of a CSI encoder and also an input of a CSI decoder, may be referred to as a CSI feedback signal. CSI feedback information or any other terms with the equivalent technical meaning. In the present disclosure, a CSI feedback signal may have a bitstream form. Herein, a bitstream means a sequence composed of binary digits, which are 0s or 1s, or bits, rather than a vector made up of floating-point numbers.

In the present disclosure, it is assumed that a base station has NV transmit antennas and a UE has 1 receive antenna. However, various embodiments described below are not applied only to a single receive antenna case but may be extended to a multi-antenna case. In addition, in descriptions below, an OFDM system using N_{c} orthogonal subcarriers will be considered.

A signal, which a UE receives through an N-th subcarrier, may be expressed by Equation 1 below.

$${y}_{n} = {h}_{n}^{H} {v}_{n} {x}_{n} + {z}_{n} , ( n = 1 , 2 , ... , {N}_{c} ) \qquad [ Equation 1 ]$$

In Equation 1, hₙ∈ [symbol] ^{N}^{ₜ}^{×1} means an instantaneous channel vector in frequency domain, Vₙ∈ [symbol] ^{N}^{ₜ}^{×1} means a precoding vector, xₙ∈ [symbol] means a data symbol transmitted in downlink, zₙ∈ [symbol] means an additive white Gaussian noise (AWGN), n means a subcarrier index, and N_{c} means the number of subcarriers.

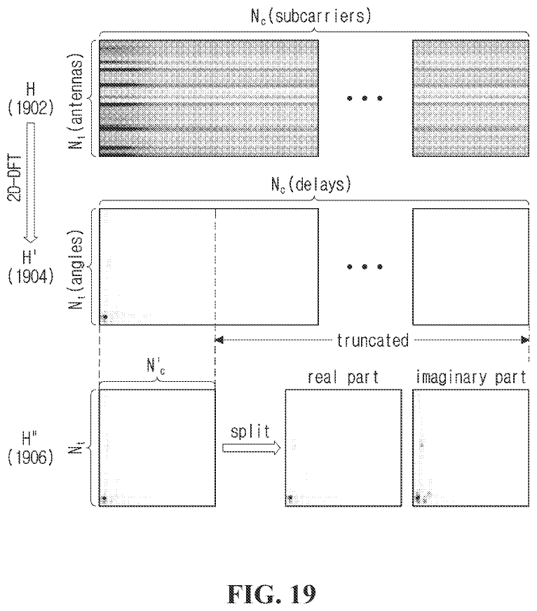

As a channel vector for the n-th subcarrier, hₙ may be estimated by a UE and fed back to a base station. In consideration of all subcarriers as a whole, only when a CSI matrix, which may be expressed as H=[hₙ, . . . , h_{N}_{_{c}}]^{H}∈ [symbol] ^{N}^{_{c}}^{×N}^{ₜ}, is properly fed back from the UE to the base station, the base station may correctly determine precoding vectors. H, which is a CSI matrix in spatial-frequency domain, may be processed as shown in FIG. 19 below. FIG. 19 illustrates an example of a processing process of a CSI matrix in a neural network for channel state information feedback. FIG. 19 represents a matrix with its rows and columns transposed compared to the conventional way of representing matrices. Referring to FIG. 19, preprocessing may be performed to sequentially perform two-dimensional (2D) discrete Fourier transform (DFT), truncation with respect to delay axis in each angular-delay domain, and split into real part and imaginary part. That is, as shown in FIG. 19, preprocessing including the following 3 steps may be performed to use a CSI network.

### (1) 2D-DFT

A CSI matrix H′ in the angular-delay domain may be obtained from the CSI matrix H in the spatial-frequency domain. The relation is H′=F_{d}HFₐ. Here, F_{d}∈ [symbol] ^{N}^{_{c}}^{×N}^{_{c}} and Fₐ∈ [symbol] ^{N}^{ₜ}^{×N}^{ₜ} are two DFT matrices.

(2) Truncation with Respect to Delay-Axis

As a time delay between multipath arrivals is present in a limited period, time delays for all the subcarriers are within a specific period. Accordingly, the CSI matrix H′ in the angular-delay domain has a large value only at first N′_{c} rows and a value close to 0 in the remaining part. Accordingly, if only the first N′_{c} rows of the CSI matrix H′ in the angular-delay domain are taken.

$${H}^{″} ∈ {ℂ}^{{N}_{c}^{′} \times {N}_{t}}$$

is obtained
(3) Split into Real Part and Imaginary Part

In the truncated CSI matrix

$${H}^{″} ∈ {ℂ}^{{N}_{c}^{′} \times {N}_{t}} ,$$

each element is a complex number, but a conventional neural network has difficult in handling a complex number. According, for handling convenience in a neural network, each element may be split into a real part and an imaginary pail, and two matrices thus generated are stacked in a third dimension, Thus, a tensor with a size of

$$2 \times {N}_{c}^{′} \times {N}_{t}$$

may be constructed.

For new data x′, a predictive probability distribution p(y′|x′,D) may be calculated based on a conditional probability in a model and a posterior probability of φ and marginalization with respect to the conditional probability in the model, as follows.

TABLE 2

| | ResNet-link | ResNet-link | Quantized | | |
|---|---|---|---|---|---|
| | Architecture | Architecture | CSI | | |
| | in Decoder | in Encoder | (bit-level) | Quantizer | Variable CR |
| CsiNet | ∘ | x | x | — | x |
| | (2 RefineNet | | | | |
| | Blocks) | | | | |
| JC-ResNet | ∘ | ∘ | ∘ | uniform | x |
| (JC: joint | (2 JC-ResNet | (a single JC- | | | |
| convolutional) | Blocks) | ResNet | | | |
| | | block) | | | |
| CsiNet + | ∘ | x | ∘ | non-uniform | ∘ |
| (CsiNetPlus) | (5 RefineNet | | | | (serial/parallel |
| | Blocks) | | | | framework) |
| CRNet | ∘ | ∘ | x | — | x |
| (channel | (2 CRBlocks) | | | | |
| reconstruction | | | | | |
| net)ConvCsi | | | | | |
| Net & | | | | | |
| ShuffleCsiNet | | | | | |
| ConvCsiNet | ∘ | x | x | — | x |
| & | (2 RefineNet | | | | |
| ShuffleCsiNetBCsiNet | Blocks) | | | | |
| (binary | | | | | |
| CsiNet) | | | | | |
| BCsiNet | ∘ | ∘ | x | — | x |
| (binary | (2~3 | (Encoder | | | |
| CsiNet)ACR | RefineNet | Head variant | | | |
| Net | Blocks) | C) | | | |
| (aggregated | | | | | |
| CRNet) | | | | | |
| ACRNet | ∘ | ∘ | ∘ | uniform | x |
| (aggregated | (2 | (2 | | | |
| CRNet) | ACRDeBlocks) | ACREnBlocks) | | | |

A CSI network architecture included in Table 2 is disclosed by a document shown in Table 3 below.

TABLE 3

| | title | authors | publication info. |
|---|---|---|---|
| CsiNet | Deep Learning for Massive | Chao-Kai Wen; | IEEE Wireless |
| | MIMO CSI Feedback | Wan-Ting Shih; Shi | Communications |
| | | Jin | Letters (2018) |
| JC-ResNet | Bit-Level Optimized Neural | Chao Lu; Wei Xu; | IEEE Wireless |
| (JC: joint | Network for Multi-Antenna | Shi Jin; Kezhi Wang | Communications |
| convolutional) | Channel Quantization | | Letters (2020) |
| CsiNet + | Convolutional Neural | Jiajia Guo; Chao-Kai | IEEE Transactions |
| (CsiNetPlus) | Network-Based Multiple- | Wen; Shi Jin; | on Wireless |
| | Rate Compressive Sensing | Geoffrey Ye Li | Communications |
| | for Massive MIMO CSI | | (2020) |
| | Feedback: Design, | | |
| | Simulation, and Analysis | | |
| CRNet | Multi-resolution CSI | Zhilin Lu; Jintao | ICC 2020 - 2020 |
| (channel | Feedback with Deep | Wang; Jian Song | IEEE International |
| reconstruction | Learning in Massive MIMO | | Conference on |
| net)ConvCsiNet & | System | | Communications |
| ShuffleCsiNet | | | (ICC) |
| ConvCsiNet | Lightweight Convolutional | Zheng Cao; Wan- | IEEE Wireless |
| & | Neural Networks for CSI | Ting Shih; Jiajia | Communications |
| ShuffleCsiNet | Feedback in Massive | Guo; Chao-Kai Wen; | Letters (2021) |
| BCsiNet | MIMO | Shi Jin | |
| (binary | | | |
| CsiNet) | | | |
| BCsiNet | Binary Neural Network | Zhilin Lu; Jintao | IEEE Wireless |
| (binary | Aided CSI Feedback in | Wang; Jian Song | Communications |
| CsiNet)ACR | Massive MIMO System | | Letters (2021) |
| Net | | | |
| (aggregated | | | |
| CRNet) | | | |
| ACRNet | Binarized Aggregated | Zhilin Lu; Xudong | IEEE Transactions |
| (aggregated | Network with Quantization: | Zhang; Hongyi He; | on Wireless |
| CRNet) | Flexible Deep Learning | Jintao Wang; Jian | Communications |
| | Deployment for CSI | Song | (2022) |
| | Feedback in Massive | | |
| | MIMO System | | |

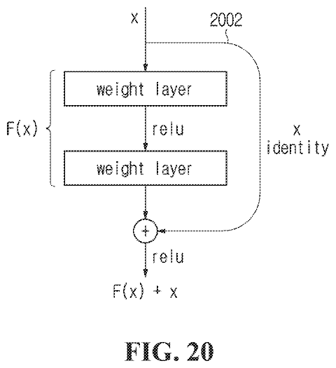

FIG. 2.0 illustrates an example of a residual block available in a neural network for channel state information feedback, FIG. 20 exemplifies a residual block that is a building block of a ResNet architecture. When a neural network architecture uses a ResNet architecture, it means that a residual block as shown in FIG. 20 is included in the overall neural network architecture. As for its feature, the residual block includes a data flows 2002 that is referred to as skip connection or identity shortcut, connection. The skip connection is a path that skips some layers and is connected directly to a layer coming after the layers, meaning a connection that adds a so-called identity signal to a signal that has passed the layers.

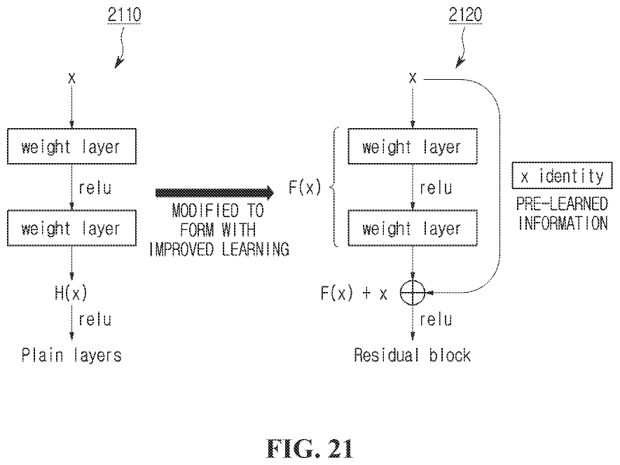

FIG. 21 illustrates an example of a residual block to which a skip connection is added. FIG. 21 shows an effect of a skip connection in a residual block. In a case 2210 without the skip connection, layers corresponding to the residual block have a signal x as input and are trained to output a signal [symbol] (x). On the other hand, in a case 2120 with the skip connection, because the signal x itself is added to an output, if layers are trained to output a residual signal that may be represented as [symbol] (x)= [symbol] (x)−x, a same effect is obtained. As not the entire [symbol] (x) but the residual [symbol] (x) is sufficient for leaning, learning becomes easier.

[symbol]

In the case of a ResNet-like architecture, a gradient may be propagated in a backpropagation process through a skip connection, which nay prevent the vanishing gradient problem that is likely to occur to multiple stacked layers. That is, as the ResNet-like architecture can overcome the vanishing gradient problem, learning may become easier.

All the CSI network architectures of Table 21 above may be understood as using a ResNet-like architecture. A type of a residual block is included in a decoder of every CST network listed in Table 2. An encoder may also include a same block as the residual block. In Table 2, it is shown that a plurality of CSI network architectures utilize a ResNet-like architecture also in an encoder.

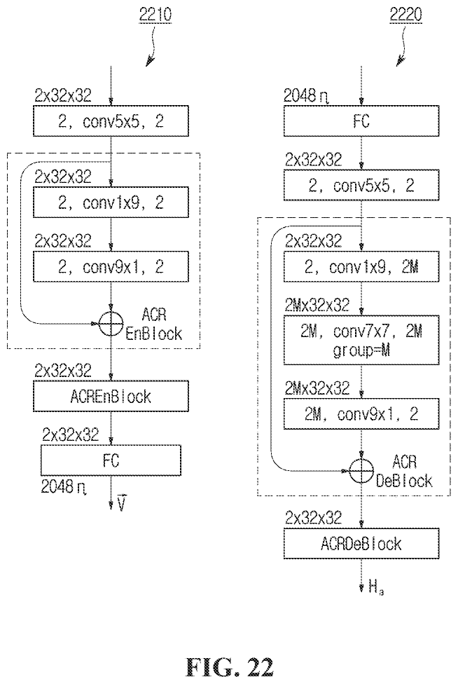

FIG. 22 illustrates an example of an encoder and decoder structure for CSI feedback. FIG. 22 exemplifies ACRNet that is an example of a CSI network architecture. Referring to FIG. 22, ACRNet is shown to include a structure of ACREnBlock, which is a type of a residual block, not only in a decoder 2220 but also in an encoder 2210.

As shown in Table 2, the existing CSI network architectures are generally a single neural network model and cannot support a variable compression ratio (CR). Accordingly, in case a feedback rate or feedback overhead varies according to a system environment, a neural network model for an encoder or decoder should be changed according to a feedback rate. A CR may be defined as a reciprocal of η, as shown in Equation 2 below.

$$η = \frac{M}{2 {N}_{c}^{′} {N}_{t}} \qquad [ Equation 2 ]$$

In Equation 2, η means a CR, MA means a dimension of a CSI feedback signal, which is a feature vector output by an encoder of a specific CSI network,

$${N}_{c}^{′}$$

means the number of subcarriers after truncation, and Nₜ means the number of transmit antennas. Accordingly, it may be understood that the encoder of the CSI network compresses

$$2 {N}_{c}^{′} {N}_{t}$$

real numbers

$$( e . g . , {H}^{″} ∈ {ℂ}^{{N}_{c}^{′} \times {N}_{t}} )$$

into M real numbers (e.g., the CST feedback signal). In the present disclosure, 1 real number is described as a 32-bit floating-point number.

In the present disclosure, an operation of outputting a feature vector in an encoder neural network of a CSI network may be referred to as feature extraction. In a digital communication system, uplink feedback is generally digital feedback that is transmissible only in a bitstream form. Accordingly, for actual deployment of a CSI network, an additional procedure of transforming a feature vector composed of real number into a bitstream form is definitely necessary. For a method for changing a feature vector composed of real numbers into a bitstream form, quantization may be considered. If an M-dimensional feature vector in a 32-bit floating point format is transmitted from a UE to a base station as it is, feature overhead will increase to a size intolerable to a system. Accordingly, when a plurality of CSI network architectures, it is not appropriate to consider a CR or η simply as the performance indicator of feedback overhead.

For example, if B-bit uniform quantization is applied to each real-number element of a feature vector, feedback overhead becomes 32/B. The number of feedback bits N_{fb} may be calculated as in Equation 3.

$${N}_{fb} = 2 {N}_{c}^{′} {N}_{t} \times η \times B \qquad [ Equation 3 ]$$

In Equation 3, N_{fb} means the number of feedback bits, N′_{c} means the number of subcarriers after truncation, N_{L} means the number of transmit antennas, η means a CR, and B means the number of quantization bits.

In the present disclosure, the number of feedback bits N_{fb} is used as a performance indicator of feedback overhead, Most of the existing CSI networks, including those mentioned in Table 2, should use a different neural network model according to a CR or η. Accordingly, a plurality of neural network models are required for a situation where the number of feedback bits N_{fb} should be changed according to a system environment.

As for CsiNet+ with a CSI network architecture that is capable of supporting variable CR, a same encoder neural network model may be use for different CRs in SM-CsiNet+ and PM-CsiNet+ that are CST network architectures. However, the use of a different decoder neural network model is still required according to each CR. Thus, because the existing CSI network architectures should use different neural network models for different CRs, when a feedback rate should change according to environments, a model of a CST network, that is, a parameter set should be changed according to the feedback rate.

For example, a feedback rate may be changed according to coherence time of a channel. That is, the feedback rate may have to be adjusted according to an environment. As the existing CSI network architectures require a neural network model of a CST network to be changed according to a feedback rate, a UE and a base station need to store a plurality of models, that is, a plurality of parameter sets. However, as the UE and the base station have a storage space as a limited resource, a CSI network architecture capable of supporting a variable feedback rate through a single model, that is, a single parameter set is needed. Thus, the present disclosure proposes an architecture of a CSI network capable of supporting a variable feedback rate using a single neural network model and an operation method thereof.

A CST network according to various embodiments supports transmission of a CSI feedback signal at different feedback rates, while using a same neural network model and a same parameter set. In the present disclosure, the proposed CSI network may be referred to as accumulable feature extraction before skip connection (ABC)-Net.

In the present disclosure, for convenience of description, compressed information, which becomes an output of a CSI encoder and an input of a CSI decoder, may be referred to as a CSI feedback signal. The present disclosure considers a case where a CST feedback signal is formed in a bitstream. The bitstream means a sequence composed of binary digits/bits of 0 or 1, not a vector composed of floating point numbers. Accordingly, in the present disclosure, a CSI feedback bitstream is treated as an output of an encoder and an input of a decoder. However, embodiments described below are not limited to signals with the bitstream form. Accordingly, a CST feedback bitstream may be referred to as a ‘CSI feedback value’, a ‘CSI value’ and the like.

A situation where different CSI feedback bitstreams are combined before being input into a decoder is exemplified as in FIG. 23 below. FIG. 23 illustrates a concept of CST feedback that supports a variable feedback rate according to an embodiment of the present disclosure. FIG. 23 shows the concept of the CSI feedback technology proposed by the present disclosure. In the proposed CSI feedback technology, different CSI feedback bitstreams may be combined before they are input into a decoder neural network 2320 of a CSI network. Accordingly, an input dimension of the decoder neural network 2320 may be retained, an architecture of the decoder neural network 2320 may be retained as it is, and furthermore, a model parameter set of the decoder neural network 2320 may also be retained as it is.

Referring to FIG. 23, irrespective of the number of CST feedback bitstreams that are combined before being input into the decoder neural network 2320, a same model of the decoder neural network 2320 may be always used. The number of feedback bits increases in proportion to the number of CST feedback bitstreams that are added and input into the decoder neural network 2320. For example, if a CSI feedback bitstream, which may be solely input into the decoder neural network 2320, has a length of 256 bits, when the number of CSI feedback bitstreams becomes 2, 3 and 4, the number of feedback bits increases to 512, 768 and 1024 respectively.

Meanwhile, even in case a same model of the decoder neural network 2320 is used, when the number of CSI feedback bitstreams input into the decoder neural network 2320 increases, CSI reconstruction performance may be improved. FIG. 23 describes improvement of CSI reconstruction performance based on an increasing number of CSI feedback bitstreams figuratively through a resolution change in the reconstructed Lenna image. Specifically, a second image 2392 reconstructed based on 2 CSI feedback bitstreams 2301 and 2302 has a higher resolution than a first image 2391 reconstructed based on 1 CSI feedback bitstream 2301. Similarly, the resolution is shown to become gradually higher in the order of a third image 2393 reconstructed based on 3 CSI feedback bitstreams 2302 to 2303 and a fourth image 2394 reconstructed based on 4 CSI feedback bitstreams 2302 to 2304.

However, in FIG. 23, the Lenna image is used only in a figurative way of description, and unlike images, an actual CST matrix or such information that can be reconstructed in a CST network is not recognizable to the human eye. The improvement of CSI reconstruction performance is described only figuratively through a resolution increase in an image, and CSI reconstruction performance should not be understood to be improved in terms of the resolution of an image. It is because of the nature of deep learning, that is, because it is difficulty to precisely explain the meanings and signal roles of different CSI feedback bitstreams that are added and input into the decoder neural network 2320.

In FIG. 23, the plurality of CSI feedback bitstreams 2301 to 2304 with different roles are combined before being input into the decoder neural network 2320. The first CSI feedback bitstream 2301 may be a signal that is capable of CSI reconstruction even when being solely input into the decoder neural network 2320. The second CSI feedback bitstream 2302 may be a signal that is capable of CSI reconstruction only when being added to the first CST feedback bitstream 2302 and input into the decoder neural network 2320. Thus, CSI feedback bitstreams, which are generated by the encoder neural network 2310, may be classified into CSI feedback bitstreams, which enable CSI reconstruction even when being solely input into the decoder neural network 2320, and CSI feedback bitstreams that enable CSI reconstruction only when being added. Herein, the former CSI feedback bitstreams may be referred to as ‘independent CSI bitstreams’, and the latter CSI feedback bitstreams may be referred to as ‘dependent CSI bitstreams’.

When the present disclosure uses such expressions as “added before being input into a decoder neural network”, “added up and input into a decoder neural network”, or “added and input into a decoder neural network”, the operation of “being added” may be understood as not only summation but also one of weighted sum and weighted average or various numerical processings derivable from them.

As shown in FIG. 23, the CSI feedback bitstreams 2301 to 2304, which play different roles and may be input into the decoder neural network 2320 after being combined, are generated by the encoder neural network 2310. An architecture of the encoder neural network 2310 will be described below.

FIG. 24 illustrates a concept of feature extraction before skip connection for supporting a variable feedback rate according to an embodiment of the present disclosure. Each of blocks 2412-1 and 2412-2 marked with dotted lines in FIG. 24 may have a ResNet-like architecture. Specifically, for the blocks 2412-1 and 2412-2, one of ACREnBlock, a JC-ResNet block in an encoder of JC-ResNet, an encoder Head variant C in BCsiNet, and a portion of an encoder structure of CRNet, or a modified structure thereof may be applied.

Referring to FIG. 24, the block 2412-1 includes a layer set 2412a-l including at least one layer and an adder 2412b-l, and the adder 2412b-1 adds up an output of the layer set 2412a-1 and an input of the layer set 2412a-1 provided from a skip connection. The layer set 2412a-1 includes at least one layer. Specifically, the layer set 2412a-1 may be at least one convolutional layer. An output block 2414-1 connected to the block 2412-1 generates a bitstream that may be transmitted as a CSI feedback signal. For example, the output block 2414-1 may include a fully-connected (FC) laver. An output of the output block 2414-1 including the FC layer may be a vector composed of real numbers.

In order to output a bipolar vector q∈{±1}^{B} that is equivalent to a bitstream including B bits as an output of an FC layer, a sign function sgn(⋅) may be used as an activation function. The sign function is also referred to as a signum function and is defined as shown in Equation 4 below

$$sgn ( x ) := \{ \begin{matrix}- 1 & if x < 0 , \\ 0 & if x = 0 , \\ 1 & if x > 0.\end{matrix} \qquad [ Equation 4 ]$$

In Equation 4, sgn (x) means a sign function for an input value x.

As for an encoder of a conventional CSI network, if there is a change in a feedback rate, an output dimension of an encoder neural network may be changed. This may cause the encoder neural network to be subject to a change in its architecture, Even when the architecture of the encoder neural network does not change according to a feedback rate, at least a model parameter set of the encoder neural network cannot help changing according to the feedback rate. It is because an encoder neural network model of a conventional CSI network outputs a CST feedback signal only for a fixed feedback rate according to a design purpose.

As shown in FIG. 24, an encoder neural network according to various embodiments may output CSI feedback bitstreams with different roles. Wien it is considered that CSI feedback bitstreams with different roles may be combined and then input into a decoder neural network as shown in FIG. 23, the CSI feedback bitstreams with different roles may be referred to as CSI feedback bitstreams with different levels. As shown in FIG. 24, CSI feedback bitstreams with different levels may be obtained from the blocks 2412-1 and 2412-2 with different positions of ResNet-like architecture.

In order to a CSI feedback bitstream with a different level from an encoder neural network architecture of ABC-Net of FIG. 24, a signal immediately before skip connection of a ResNet architecture is input into the output block 2414-1 or 2414-2, and the output block 2414-1 or 2414-2 outputs a CSI feedback bitstream 2401 or 2402. That is, performing feature extraction by using a residual signal immediately being added to an identity signal may be a feature of the proposed ABC-Net architecture. That is, ABC-Net has a feature of feature extraction before skip connection. However, a feature vector extracted before skip connection is a signal that is accumulable in a decoder. Accordingly, this may be understood as extraction of an accumulable feature. That is, ABC-Net has a feature of accumulable feature extraction before skip connection.

As for one feature of ABC-Net, it may understood that an encoder neural network performs feature extraction by using a residual signal before skip connection. This feature aims for generating CST feedback bitstreams with different levels that may be combined before being input into a decoder neural network. That is, a feedback signal, which has, as it feature, a combining operation not skipped in an encoder but performed before the feedback signal is input into a decoder, is proposed as a CSI feedback signal of a CSI network according to various embodiments.

Hereinafter, as an example of a CSI network with the above-described feature, an embodiment supporting a maximum of 2 CSI feedback bitstreams will be described.

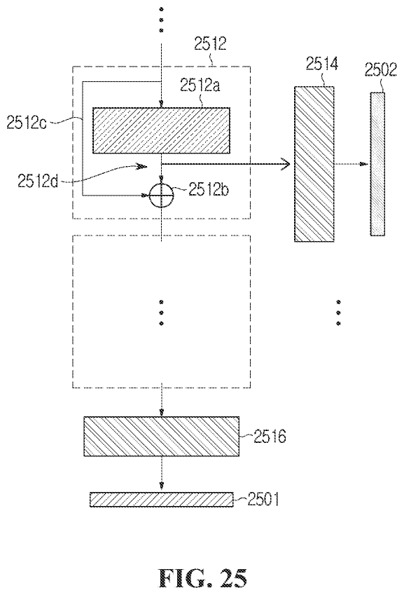

FIG. 25 illustrates an example of an encoder neural network that supports a variable feedback rate according to an embodiment of the present disclosure. FIG. 25 exemplifies an architecture for a total of two types of CSI feedback bitstreams that are transmitted as uplink feedback from a UE to a base station. A first CSI feedback bitstream 2501 is a signal capable of reconstructing channel information, even when being solely input into a decoder neural network. On the other hand, a second CSI feedback bitstream 2502 may reconstruct CSI in a decoder neural network, only when being combined with the first CSI feedback bitstream 2501.

The CSI feedback bitstream 2501 includes a feature value generated by a first output layer 2516 connected to a path including all internal blocks. Herein, all the internal blocks include all remaining hidden layers except another output layer (eg, a second output layer 2514). As the first output layer 2516 generates the first CSI feedback bitstream 2501 that may be decoded alone, it may be referred to as a ‘main output layer’ or any other terms with an equivalent technical meaning.

The second CSI feedback bitstream 2502 includes a feature value generated by a second output layer 2514 connected to a path including a portion of the internal blocks. The second output layer 2514 corresponds to a unit block 2512 that includes some layers 2512a in the encoder neural network, an operator 2512b and a skip path 2512c. Herein, the second output layer 2514 generates a feature value by using a signal at a point 2512d before an endpoint of the skip path 2512c among various points within the unit block 2512. As the second output layer 2514 generates the second CST feedback bitstream 2502 that cannot be decoded alone, it may be referred to as a ‘supplementary output layer’ or any other terms with an equivalent technical meaning.

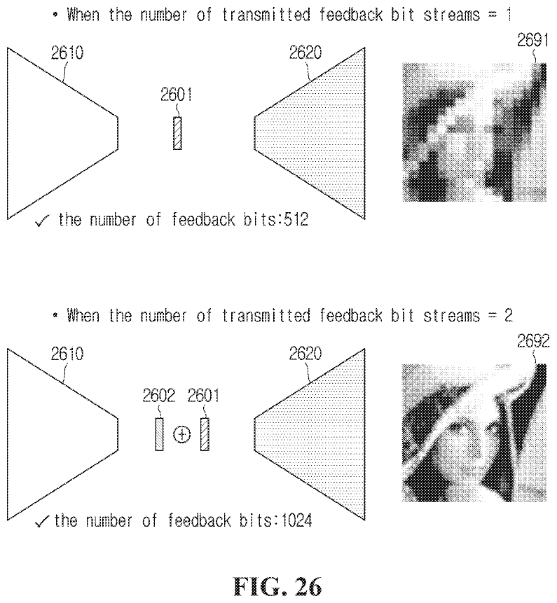

FIG. 26 illustrates examples of reconstructed channel information according to a change of feedback rate according to an embodiment of the present disclosure. Referring to FIG. 26, when there is one feedback bitstream, an encoder neural network 2610 outputs a first CSI feedback bitstream 2601, and a decoder neural network 2620 reconstructs channel information from the first CSI feedback bitstream 2601. When there are 2 feedback bitstreams, the encoder neural network 2610 outputs the first CSI feedback bitstream 2601 and the second CST feedback bitstream 2602, and the decoder neural network 2620 reconstructs channel information from a combination of the first CST feedback bitstream 2601 and the second CSI feedback bitstream 2602.

The first CSI feedback bitstream 2501, which may be decoded along even when not being combined with another signal, may be obtained by feature extraction that is performed after skip connection. On the other hand, the second CSI feedback bitstream 2502, which may be input into a decoder neural network by being added to another signal, may be obtained by feature extraction that is performed before skip connection. CSI feedback bitstreams at different levels may be obtained from blocks with different positions of a ResNet architecture.

Referring to FIG. 26, when only one CSI feedback bitstream is transmitted from a UE to a base station, the number of feedback bits may be 512. In case 2 CSI feedback bitstreams are all transmitted from a UE to a base station, the number of feedback bits may be 1024. In case a combination of 2 CSI feedback bitstreams is input into a decoder neural network, CSI reconstruction performance may be better than when only one CST feedback bitstream is input into the decoder neural network. Like FIG. 23, FIG. 26 describes improvement of CSI reconstruction performance according to an increase in the number of CSI feedback bitstreams figuratively through improved resolutions of the Lenna image.

CSI feedback bitstreams at different levels may be output by a same encoder neural network model with a same parameter set. Both when one CSI feedback bitstream alone is input into a decoder neural network and when a combination of 2 different CSI feedback bitstreams is input into a decoder, a same decoder neural network model with a same parameter set may be used. That is, irrespective of the number of CSI feedback bitstreams that are transmitted from a UE to a base station, a same encoder neural network model and a same decoder neural network model may always be used.

As described above, a plurality of CSI feedback bitstreams may be transmitted from a UE to a base station. Herein, the plurality of CSI feedback bitstreams may be transmitted during one CSI feedback occasion or transmitted sequentially over a plurality of CSI feedback occasions. Even when CSI feedback bitstreams are transmitted in a distributed way over a plurality of CSI feedback occasions, if the plurality of CSI feedback occasions all belong to a period within a coherence time of a channel, the CSI feedback bitstreams may be understood as representing a same channel.

As described above, a CSI network supporting a variable rate using accumulable CSI feedback bitstreams may be constructed. A CSI network according to various embodiments may be applied to various environments, Hereinafter, operations of a base station and a UE will be described for a case where a CSI network based on the proposed technology is applied for downlink channel estimation. However, a CSI network according to various embodiments may be applied to other types of links including uplink and sidelink, and in this case, procedures described below may be performed by being partially modified.

FIG. 27 illustrates an example of a procedure of obtaining channel information based on CSI feedback according to an embodiment of the present disclosure. FIG. 27 exemplifies a method for operating a base station.

Referring to FIG. 27, at step S2701, a base station transmits configuration information related to CSI feedback. The configuration information may include at least one of information related to reference signals transmitted for channel measurement (e.g., a resource, a sequence, etc.), information related to a channel measurement operation, or information related to feedback (e.g., a format, a resource, the number of feedback times, a cycle, etc.). In addition, according to various embodiments, the configuration information may further include information indicating a rate for the CST feedback.

At step S2703, the base station transmits the reference signals. The base station transmits the reference signals based on the configuration information. That is, the base station may transmit the reference signals based on a sequence indicated by the configuration information through a resource indicated by the configuration information.

At step S2705, the base station receives CSI feedback information. That is, the base station receives the CSI feedback information that is generated based on the transmitted reference signals. According to various embodiments, the CSI feedback information includes at least one CSI value generated by an encoder neural network of a CST network. Herein, the at least one CSI value may include at least one of CSI feedback bitstreams that are to be combined before being input into a decoder. In case a plurality of CST values are included, the plurality of CST values may be received during one CSI feedback occasion or sequentially received over a plurality of CSI feedback occasions with an interval within a coherence time of a channel. In this case, according to an embodiment, the CSI feedback information may be control information necessary for a decoding operation and include an indicator indicating that the CST values are transmitted over the plurality of CSI feedback occasions.

At step S2707, the base station obtains channel information. In other words, the base station reconstructs the channel information based on at least one CSI value included in the CST feedback information. According to various embodiments, the base station may input at least one CSI value into the encoder neural network of the CSI network and perform a predictive operation to obtain the reconstructed channel information. Herein, in case a plurality of CSI values are received, the base station may generate an input value by combining the plurality of CSI values and input the input value into the encoder neural network. Herein, the CSI value and the input value have a same dimension. Specifically, the input value is generated by an arithmetic operation of addition for the plurality of CST values, for example, by summing the plurality of CST values, performing weighted summation, or calculating a weighted average.

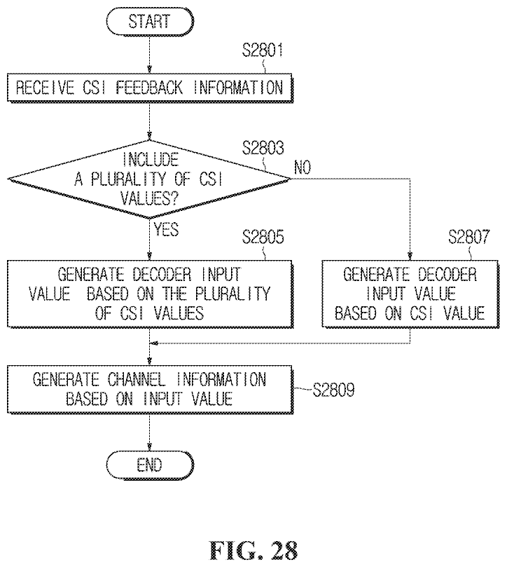

FIG. 28 illustrates an example of a procedure of operating a decoder neural network of a CSI network according to an embodiment of the present disclosure. FIG. 28 exemplifies a method for operating a base station. However, depending on a link type of a channel to be measured, the operations exemplified in FIG. 28 may be performed by another device (e.g., UE).

Referring to FIG. 28, at step S2801, a base station receives CSI feedback information. That is, the base station receives the CSI feedback information including at least one CSI value generated by an encoder neural network of a CSI network. In case a plurality of CSI values are included, the plurality of CSI values may be received during one CSI feedback occasion or sequentially received over a plurality of CSI feedback occasions with an interval within a coherence time of a channel.

At step S2803, the base station checks whether the CSI feedback information includes a plurality of CSI values. Whether the CSI feedback information includes a plurality of CSI values may be determined for a plurality of CSI feedback occasions. In this case, the base station may determine whether the CSI feedback information includes a plurality of CSI values, according to whether a CSI value received on a current CSI feedback occasion and a CSI value received on a previous CSI feedback occasion are to be combined with each other. Herein, determining whether a plurality of CSI values are included may be replaced by determining whether a feedback rate is greater than a minimum rate.

If the CSI feedback information includes a plurality of CSI values, at step S2805, the base station generates a decoder input value based on the plurality of CSI values. The base station operates a decoder neural network of a CSI network and obtains channel information by using the decoder neural network. Accordingly, the base station generates an input value for the decoder neural network based on the plurality of received CSI values. Specifically, the input value is generated by an arithmetic operation of addition for the plurality of CSI values, for example, by summing the plurality of CSI values, performing weighted summation, or calculating a weighted average.

If the CSI feedback information includes a single CSI value, at step S2807, the base station generates a decoder input value based on the CSI value. Herein, the CSI value includes a CSI value that may be decoded without being combined. Accordingly, the base station may use the received CSI value itself as an input value for the decoder neural network.

At step S2809, the base station generates channel information based on the input value. In other words, the base station may input the input value into the decoder neural network and obtain reconstructed channel information by performing a predictive operation. Herein, the predictive operation may be performed by the base station or performed by a third device (e.g., cloud server). In case the predictive operation is performed by a third device, the base station may transmit the input value to the third device and receive a predicted result from the third device. The generated channel information may be used for scheduling for a UE (e.g., resource allocation, precoding, etc.).

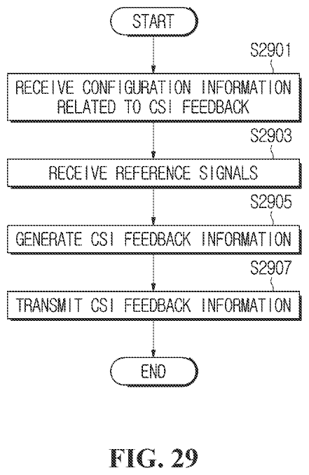

FIG. 29 illustrates an example of a procedure of transmitting CST feedback according to an embodiment of the present disclosure. FIG. 29 exemplifies a method for operating a UE.

Referring to FIG. 29, at step S2901, a UE receives configuration information related to CSI feedback. The configuration information may include at least one of information related to reference signals transmitted for channel measurement (e.g., a resource, a sequence, etc.), information related to a channel measurement operation, or information related to feedback (e.g., a format, a resource, the number of feedback times, a cycle, etc.). In addition, according to various embodiments, the configuration information may further include information indicating a rate for the CSI feedback.

At step S2903, the UE receives the reference signals. The UE transmits the reference signals based on the configuration information. That is, the UE may receive the reference signals based on a sequence indicated by the configuration information through a resource indicated by the configuration information. Thus, the UE may obtain reception values or measurement values for the reference signals.

At step S2905, the UE generates CSI feedback information. According to various embodiments, the CSI feedback information includes at least one CSI value generated by an encoder neural network of a CSI network. The UE may generate an input value of the encoder neural network based on the reception values or the measurement values for the reference signals and obtain at least one CSI value by performing a predictive operation. The at least one CSI value is output from at least one of a plurality of output layers of the encoder neural network. Herein, the output layers may include a final output layer, which outputs an independent CST value that is independently decodable without being combined with any other CSI value, and at least one cumulative output layer that outputs a dependent CSI value that need to be combined with an independent CSI value for decoding.

At step S2907, the UE transmits CSI feedback information. The UE may transmit the CSI feedback information based on the configuration information that is received at step S2901. The CSI feedback information may be transmitted through at least one feedback occasion that is included in a coherence time. In case the CSI feedback information is transmitted over a plurality of CSI feedback occasions, the CSI values may be sequentially transmitted through a plurality of messages. In this case, according to an embodiment, the CST feedback information may include control information necessary for a decoding operation. For example, the control information may include an indicator indicating that the CST values are transmitted through the plurality of CST feedback occasions. Specifically, the control information may include an indicator indicating that at least one CSI value to be transmitted on a next CSI feedback occasion may be combined with at least one CSI value transmitted on a current CSI feedback occasion, and an indicator indicating that at least one CSI value transmitted on a current CST feedback occasion may be combined with at least one CSI value transmitted on a previous CSI feedback occasion.

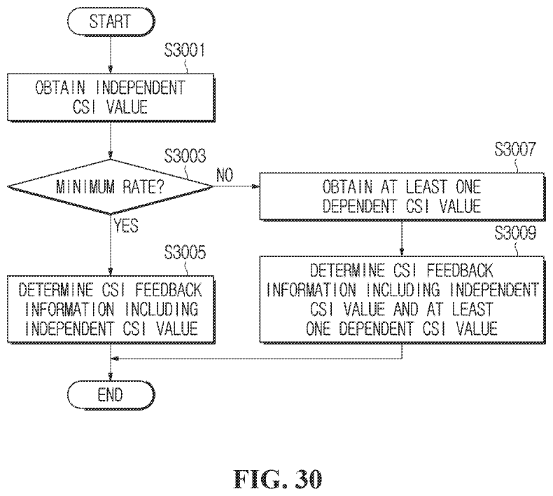

FIG. 30 illustrates an example of a procedure of operating an encoder neural network of a CSI network according to an embodiment of the present disclosure. FIG. 30 exemplifies a method for operating a UE. However, depending on a link type of a channel to be measured, the operations exemplified in FIG. 28 may be performed by another device (e.g., base station).

Referring to FIG. 30, at step S3001, a UE obtains an independent CSI value. To this end, the UE may input an input value, which is generated based on a reception value for reference signals, into an encoder neural network and obtain an output value of a main output layer connected to a path including all internal blocks (e.g., hidden layers) in the encoder neural network, thereby obtaining the independent CSI value.

At step S3003, the UE checks whether a feedback rate is a minimum rate. For example, the UE may determine the feedback rate based on at least one of signaling from a base station, a size of an allocated CSI feedback resource, quality of an uplink channel, or a capability of the encoder neural network used in the UE. Herein, determining the feedback rate may be replaced by an operation of determining the number of CSI values that are to be transmitted to report channel information. In this case, the UE checks whether the channel information is to be reported with only one CST value.

If the feedback rate is a minimum rate, at step S3005, the UE determines CSI feedback information including an independent CSI value. That is, the UE generates the CST feedback information that includes only the independent CSI value without a dependent CSI value. Herein, apart from the independent CSI value, the CSI feedback information may further include control information that is necessary to operate a decoder neural network.

If the feedback rate is not a minimum rate, at step S3007, the UE obtains at least one dependent CSI value. According to various embodiments, the UE may obtain the at least one dependent CSI value by obtaining an output value of at least one of supplementary output layers connected to a path including a portion of blocks (e.g., hidden layers) in the encoder neural network. Herein, the supplementary output layer generates a CSI value by using a signal before it is added to skip connection.

At step S3009, the UE determines CSI feedback information that includes the independent CSI value and the at least one dependent CST value. That is, the UE generates the CSI feedback information including a plurality of CSI values. Herein, apparat from the independent CSI value, the CSI feedback information may further include control information that is necessary to operate a decoder neural network. Herein, although not illustrated in FIG. 30, the plurality of CSI values may be sequentially transmitted over a plurality of CSI feedback occasions through a plurality of messages.

For performance comparison of ABC-Net, ACRNet and ACRNet-bipolar, which is a CSI network architecture constructed by partially modifying ACRNet, are used as baselines. Hereinafter, the present disclosure will compare 3 techniques of ABC-Net, ACRNet-bipolar, and ACRNet to which uniform quantization is applied.

The ACRNet architecture, which is used as a baseline for performance comparison, is ACRNet−1X with η=¼, to which uniform quantization with B=2 is applied. ACRNet−1X with η=¼, to which 2-bit uniform quantization is applied, is used as a baseline because it is the only method with 1024 feedback bits f among feedback methods using the ACRNet architecture for which performance has been reported.

In ABC-Net, a CSI feedback signal in a bitstream form may be immediately generated as an output of an encoder neural network. However, in ACRNet, since an output of an encoder neural network is a feature vector composed of real numbers, performance of ACRNet as a result of application of uniform quantization may be considered for comparison. However, as the application of uniform quantization is known to be sub-optimal, it cannot be equivalent comparison in terms of CSI reconstruction performance, and an indicator of complexity for quantization (e.g., an amount of computation and a volume of storage space) may be rather different from an indicator of complexity for a neural network (e.g., an amount of computation and a volume of storage space), which makes it difficult to calculate the complexities represented by those different indicators (e.g., an amount of computation and a volume of storage space) in an integrated way.

Accordingly, ACRNet-bipolar, which a CSI network architecture constructed by modifying ACRNet, is used such that a bitstream may be output immediately from an encoder neural network and the bitstream output from the encoder neural network may be input immediately into a decoder neural network. ACRNet-bipolar is an architecture devised for performance comparison with the proposed technology of ABC-Net, matching an output dimension of a last FC layer of an encoder and an input dimension of a first FC layer of a decoder to the number of feedback bits in the existing ARCNet and applying a sign function sgn (⋅) as an activation function of the last FC layer of the encoder. All the other parts of the architecture is the same as ACRNet. ACRNet-bipolar, which is used for an experiment for performance comparison, is modified based on ACRNet-1X that is used for the experiment.

ABC-Net, which is used for the experiment for performance comparison, has a total of 2 types of CSI feedback bitstreams that are transmitted, and one CSI feedback bitstream is composed of 512 bits. Accordingly, ABC-Net used for the experiment may support two cases of 512 feedback bits or 1024 feedback bits. Accordingly, the performance of ABC-Net is compared with a total of 3 baselines, that is, ACRNet to which uniform quantization is applied such that the number of feedback bits becomes 1024, ACRNet-bipolar with 512 feedback bits, and ACRNet-bipolar with 1024 feedback bits. As the performance of an ACRNet architecture to which uniform quantization is applied to make feedback bits as many as 512 is not known yet, it is excluded from the performance comparison.

An encoder structure of ABC-Net, which is used for the experiment for performance comparison, is obtained by attaching an additional FC layer to the encoder of ACRNet-bipolar with 512 feedback bits, and the additional FC layer is connected immediately before skip connection in a first ACREnBlock. An encoder neural network architecture of ABC-Net used for the experiment may be the same as the encoder neural network architecture illustrated on the left side of FIG. 25. A decoder neural network architecture of ABC-Net used for the experiment is the same as a decoder neural network architecture of ARCNet-bipolar with 512 feedback bits.

As for experimental conditions and setups, an indoor scenario at 5.3 GHz is considered, the number of subcarriers and the number of transmit antennas are N_{c}=1024 and Nₜ=32 respectively, and a uniform linear array (ULA) model is used as a massive MIMO system.

$${N}_{c}^{′} = 32$$

is used, and 1,000,000 CSI matrices and 20,000 CSI matrices, which are generated independently of each other, are used as training datasets and test datasets, respectively.

In the present disclosure, the normalized mean squared error (NMSE) and the cosine similarity ρ are used as performance indicators for CSI reconstruction. If an output of a decoder neural network of a CSI network is

$$∈ {ℂ}^{{N}_{c}^{′} \times {N}_{t}} ,$$

NMSE is defined as shown in Equation 5 below.

$$NMSE = 𝔼 [ \frac{{‖ - {H}^{″} ‖}_{2}^{2}}{{‖ {H}^{″} ‖}_{2}^{2}} ] \qquad [ Equation 5 ]$$

In Equation 5, [symbol] means the output of the decoder neural network of the CSI network, and H″ means an original channel.

In addition, if [symbol] is a reconstructed channel vector of an n-th subcarrier, the cosine similarity ρ may be calculated by Equation 6 below.

$$ρ = 𝔼 [ \frac{1}{{N}_{c}} {\sum }_{n = 1}^{{N}_{c}} \frac{\vert {H}^{} {h}_{n} \vert}{{‖ ‖}_{2} {‖ {h}_{n} ‖}_{2}} ] \qquad [ Equation 6 ]$$

In Equation 6, ρ means the cosine similarity, N_{c} means the number of subcarriers, hₙ means an original channel vector of an n-th subcarrier, and [symbol] means a reconstructed channel vector of the n-th subcarrier.

In the experiment, not all the subcarriers were used to calculate ρ, but only first 125 subcarriers were compared.

Table 4 shows the CSI reconstruction performance and complexity of the proposed ABC-Net. In Table 4, the proposed ABC-Net is compared with the baselines.

TABLE 4

| the number | | | | | |
|---|---|---|---|---|---|
| of | | | | | |
| feedback | | Complexity | | Performance | |
| bits | Methods | FLOPs | params | NMSE | ρ |
| 512 | ACRNet | / | / | / | / |
| | ACRNet-bipolar | 4.743M | 2.102M | −10.8033 | 0.9577 |
| | ABC-Net | — | — | −9.9006 | 0.9514 |
| 1024 | ACRNet | 4.64M | 2.102M | −13.61 | / |
| | ACRNet-bipolar | 6.840M | 4.200M | −12.9943 | 0.9734 |
| | ABC-Net | 5.792M | 3.151M | −12.6154 | 0.9712 |

In Table 4, the proposed technology ABC-Net is operated with a same model and a same parameter set. “-” means ‘no extra amount needed’, and “/” means ‘not reported’.

In Table 4, FLOPs is the number of floating point operations as an indicator for an amount of computation of a neural network model, and params is the number of parameters of a neural network model, indicating a storage space necessary for storing the model. M is the abbreviation of mega, meaning 106. NMSE is expressed in decibel (DB). In Table 4, ABC-Net shows comparable CSI reconstruction performance to the baselines, despite using a same model and a same parameter set all the time irrespective of different numbers of feedback bits.

When ACRNet-bipolar is used to support both feedback rates of 512 bits and 1024 bits, as many parameters as 2.102M+4.200M=6.302M are required, but when the proposed ABC-Net is used, 3151M parameters are required, which may save up to 50% of the storage space.

In case the proposed ABC-Net is operated at the feedback rate of 512 bits, the additional attached FC layer does not have to be used. Thus, it may be operated with a same amount of computation as ACRNet-bipolar with 512 feedback bits. In case the proposed ABC-Net is operated at the feedback rate of 1024 bits, 5.792M FLOPs are required, which is equal to 84.7% of 6.840M FLOPs required by ACRNet-bipolar, and thus a saving effect on the amount of computation may be calculated to be 15.3% or above. In the case of ACRNet, additional complexity is required for quantization and dequantization operations, and it is notable that such additional complexity is excluded from Table 4.

Generally, as there is a quantization error, an approach of quantizing a real number feature vector into a bitstream has limited performance in an environment where the number of feedback bits N_{fb} is small. Accordingly, in an environment where the number of feedback bits N_{fb} is small, a method with an output of an encoder neural network itself being a bitstream may be more advantageous than a method of applying quantization. However, among methods of which performance is reported concerning ARCNet, a method with a smallest number of feedback bits N_{fb} has 1024 feedback bits. Thus, it is notable that the present disclosure inevitably used ACRNet-1X with η=¼, to which 2-bit uniform quantization is applied, as a baseline for performance comparison.

When the proposed ABC-Net is used, a feedback rate may be adaptively applied in consideration of a downlink channel environment like a coherence time and an uplink resource situation. For example, in a situation where an uplink resource is limited, a UE may transmit only a CST feedback bitstream that may be decoded alone, and immediately after a base station receives the CST feedback bitstream, if an uplink resource is additionally given within a coherence time for a downlink channel, different CSI feedback bitstreams may not all sent, but only CSI feedback bitstreams to be further added may be sent except the CSI feedback that is already received by the base station.

The above-described effects of the proposed technology may be summarized as follows. A feedback rate may be adaptively applied according to a downlink channel environment and an uplink resource situation. In addition, the complexity of a neural network model may be reduced. Furthermore, a required storage space and a required computing resource may be saved.

As the examples of the proposal method described above may also be included in one of the implementation methods of the present disclosure, it is an obvious fact that they may be considered as a type of proposal methods. In addition, the proposal methods described above may be implemented individually or in a combination (or merger) of some of them. A rule may be defined so that information on whether or not to apply the proposal methods (or information on the rules of the proposal methods) is notified from a base station to a terminal through a predefined signal (e.g., a physical layer signal or an tipper layer signal).

The present disclosure may be embodied in other specific forms without departing from the technical ideas and essential features described in the present disclosure. Therefore, the above detailed description should not be construed as limiting in all respects and should be considered as an illustrative one. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

### INDUSTRIAL APPLICABILITY

The embodiments of the present disclosure are applicable to various radio access systems. Examples of the various radio access systems include a 3^{rd} generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
receiving configuration information related to channel state information (CSI) feedback;
receiving reference signals based on the configuration information;
generating CSI feedback information based on the reference signals; and
transmitting the CSI feedback information,
wherein the CSI feedback information includes a corresponding number of CSI values to a feedback rate.

2. The method of claim 1, wherein the CSI values include an independent output value that is output from an output layer of an encoder neural network that generates the CSI values, and at least one dependent output value that is output from at least one different output layer included in the encoder neural network.

3. The method of claim 2, wherein the dependent output value is generated based on a signal that is extracted in a unit block constituting the encoder neural network,
wherein the unit block includes at least one layer and a skip connection that connects an input end of the at least one layer to an output end of the at least one layer, and
wherein the dependent output value is generated based on an output of the at least one layer.

4. The method of claim 2, wherein the independent output value and the at least one dependent output value are sequentially transmitted over a plurality of CSI feedback occasions.

5. The method of claim 1, wherein the configuration information indicates the feedback rate.

6. The method of claim 1, further determining the feedback rate based on channel quality.

7. A method comprising:
transmitting configuration information related to channel state information (CSI) feedback;
transmitting reference signals based on the configuration information;
receiving CSI feedback information corresponding to the reference signals; and
obtaining channel information based on the CSI feedback information,
wherein the CSI feedback information includes a corresponding number of CSI values to a feedback rate.

8. The method of claim 7, further comprising generating an input value of a decoder neural network based on a plurality of CSI values included in the CSI feedback information.

9. The method of claim 8, wherein the input value is generated by an arithmetic operation of addition for the plurality of CSI values.

10. The method of claim 8, wherein the input value is generated by summing the plurality of CSI values, performing weighted summation, or calculating a weighted average.

11. The method of claim 7, wherein the configuration information indicates the feedback rate.

12. A user equipment (UE) comprising:
a transceiver; and
a processor coupled with the transceiver,
wherein the processor is configured to:
receive configuration information related to channel state information (CSI) feedback,
receive reference signals based on the configuration information,
generate CSI feedback information based on the reference signals, and
transmit the CSI feedback information, and
wherein the CSI feedback information includes a corresponding number of CSI values to a feedback rate.

13-15. (canceled)

16. The UE of claim 12, wherein the CSI values include an independent output value that is output from an output layer of an encoder neural network that generates the CSI values, and at least one dependent output value that is output from at least one different output layer included in the encoder neural network.

17. The UE of claim 16, wherein the dependent output value is generated based on a signal that is extracted in a unit block constituting the encoder neural network,
wherein the unit block includes at least one layer and a skip connection that connects an input end of the at least one layer to an output end of the at least one layer, and
wherein the dependent output value is generated based on an output of the at least one layer.

18. The UE of claim 16, wherein the independent output value and the at least one dependent output value are sequentially transmitted over a plurality of CSI feedback occasions.

19. The UE of claim 12, wherein the configuration information indicates the feedback rate.

20. The UE of claim 12, wherein the processor is further configured to:
determine the feedback rate based on channel quality.
